(19) United States
(12) Patent Application Publication
(10) Pub. No.: US 2015/0039403 A1
(43) Pub. Date: Feb. 5, 2015

(54) PREVENTING MAN-IN-THE-MIDDLE ATTACKS IN ELECTRONIC VOTING

(71) Applicant: Everyone Counts, Inc., San Diego, CA (US)

(72) Inventors: Roy Grossberg, San Diego, CA (US); Sean Mostafavi, San Diego, CA (US)

(73) Assignee: Everyone Counts, Inc., San Diego, CA (US)

(21) Appl. No.: 13/958,383

(22) Filed: Aug. 2, 2013

(51) Int. Cl. G07C 13/00

(52) U.S. Cl. CPC G07C 13/00
USPC 705/12

(57) ABSTRACT

In one aspect, there is provided a method. The method may include receiving, at a processor including a user interface, an indication representative of an electronic ballot cast electronically; interpreting, by the processor including the user interface in response to the received indication, data associated with the electronic ballot; generating, by the processor including the user interface, a ballot image of the interpreted electronic ballot, without accessing at least one of another device or another server to perform the interpreting or the generating; sending, by the processor, the generated ballot image to a server containing one or more other ballot images to enable auditing of the ballot images. Related systems, methods, and articles of manufacture are also disclosed.

### TECHNICAL FIELD

The subject matter described herein relates generally to data processing and, in particular, electronic voting.

### BACKGROUND

Electronic voting refers to voting electronically. For example electronic voting may be used by voters to access a ballot via a processor, such as a personal computer. The ballot is presented electronically to allow a user to cast a vote, and then the cast ballot can be submitted electronically and/or printed and submitted with other cast ballots to determine the results of the vote. The electronic voting process can thus be used to efficiently vote for political candidates, propositions, corporate board of directors, and anything else.

### SUMMARY

In one aspect, there is provided a method. The method may include receiving, at a processor including a user interface, an indication representative of an electronic ballot cast electronically; interpreting, by the processor including the user interface in response to the received indication, data associated with the electronic ballot; generating, by the processor including the user interface, a ballot image of the interpreted electronic ballot, without accessing at least one of another device or another server to perform the interpreting or the generating; sending, by the processor, the generated ballot image to a server containing one or more other ballot images to enable auditing of the ballot images.

In some variations, one or more of the features disclosed herein including the following features can optionally be included in any feasible combination. The user interface may present the electronic ballot and allow interacting with the electronic ballot including making at least one selection on the electronic ballot. The user interface may further include at least one of a browser or a client application. The data may further include a markup language. The processor may encrypt the generated ballot image. The processor may send the generated ballot image after the encrypting. The generated ballot image may be formed as a .png file. The ballot image may be audited at the server by comparing the ballot image with voting information obtained from at least three other voting channels.

Implementations of the current subject matter can include, but are not limited to, systems and methods consistent including one or more features are described as well as articles that comprise a tangibly embodied machine-readable medium operable to cause one or more machines (for example, computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (for example the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a system for configuring a voting machine to prevent man-in-the-middle attacks of ballot images presented at the voting machine by generating the ballot images at the voting machine, in accordance with some example implementations;

FIG. 1B depicts an example of a process for generating the ballot images at the voting machine, in accordance with some example implementations;

FIG. 1C depicts an example of a system for auditing election results, in accordance with some example implementations;

FIG. 2A depicts an example of a process for auditing election results, in accordance with some example implementations;

FIG. 2B depicts another example of a process for auditing election results, in accordance with some example implementations;

FIG. 2C depicts an example of a ballot;

FIG. 3 depicts an example of using two keys to separately encrypt the voter's identity and the voter's votes;

FIGS. 4A, 4B, 4C, and 4D depict examples of voting channels which may be audited in accordance with some example embodiments; and

FIG. 5 depicts another example process for auditing votes stored in a plurality of ballot boxes including electronic and physical ballot boxes, in accordance with some example embodiments.

When practical, similar reference numbers denote similar structures, features, or elements.

### DETAILED DESCRIPTION

In some electronic voting system, an electronic voting device including a user interface, such as a browser and the like, may present an electronic ballot to a voter. This electronic ballot may be defined in a markup language document, such as a hypertext markup language document (HTML), extensible markup language (XML) document, and the like. When a voter selects for example a candidate on the electronic ballot, a message containing data, such as HTML and other metadata, may be sent back to a server, which then interprets the data and generates an image for the ballot including the selections. The server then sends the generated image of the electronic ballot including selections to the voting device and user interface, which then presents the electronic ballot including the selection for display. However, this server-side rendering of the electronic ballot represents a security risk with respect to a man-in-the-middle attack. For example, when the voting device including the user interface sends data back to the voting server for rendering, an attack on that data could be performed, thus compromising the integrity of the voter's selections.

The subject disclosed herein may, in some example implementations, relate to preventing, or reducing the likelihood of success of, an attack, such as a man-in-the-middle attack, between a voting device and a voting server.

In some example implementations, the voting device performs client-side rendering of the electronic ballot, so data is not sent to a server, voting server, or any other device for rendering.

In some example implementations, the voting device may perform client-side rendering of the electronic ballot. Moreover, the when a voter is ready to submit a vote for tallying, this submission may initiate the client-side rendering of the electronic ballot. And, this client-side rendered electronic ballot (including any selections) may be sent securely to a server for tallying, auditing, and the like. The electronic ballot may be sent securely by encrypting the image containing the electronic ballot.

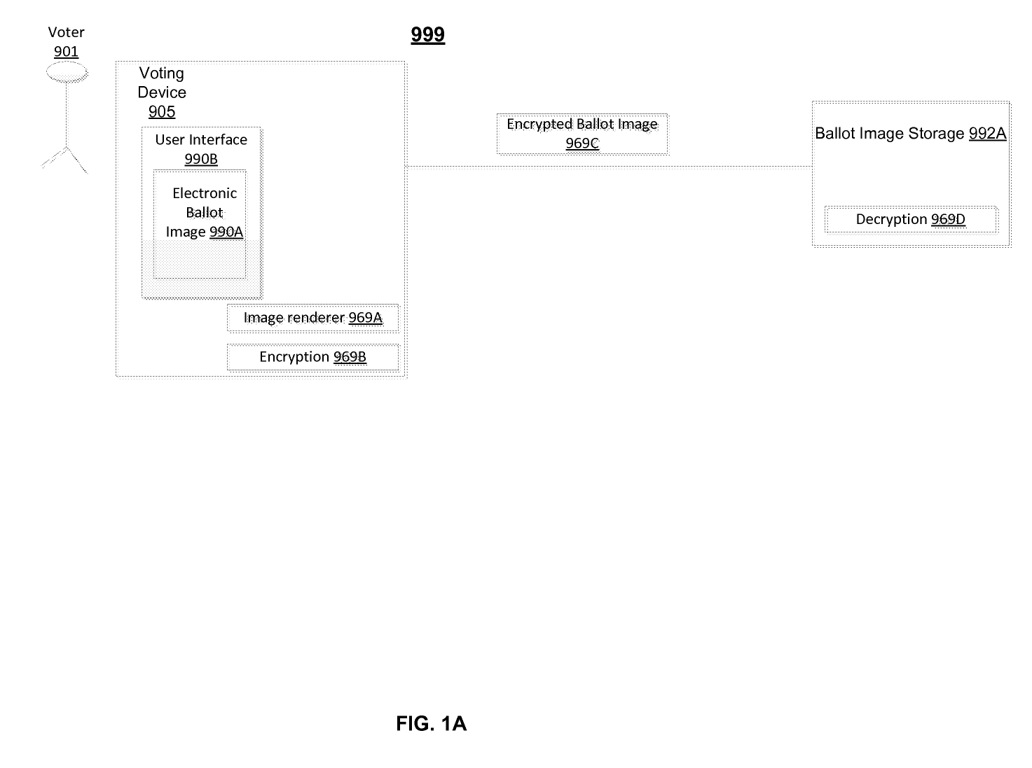

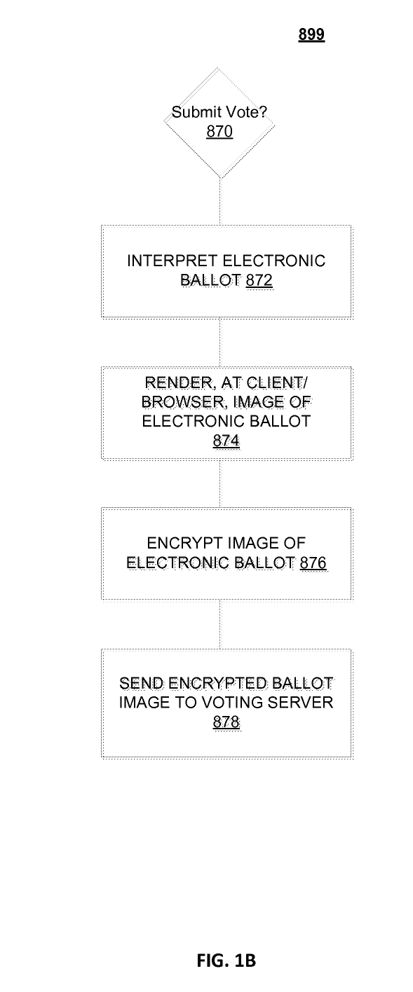

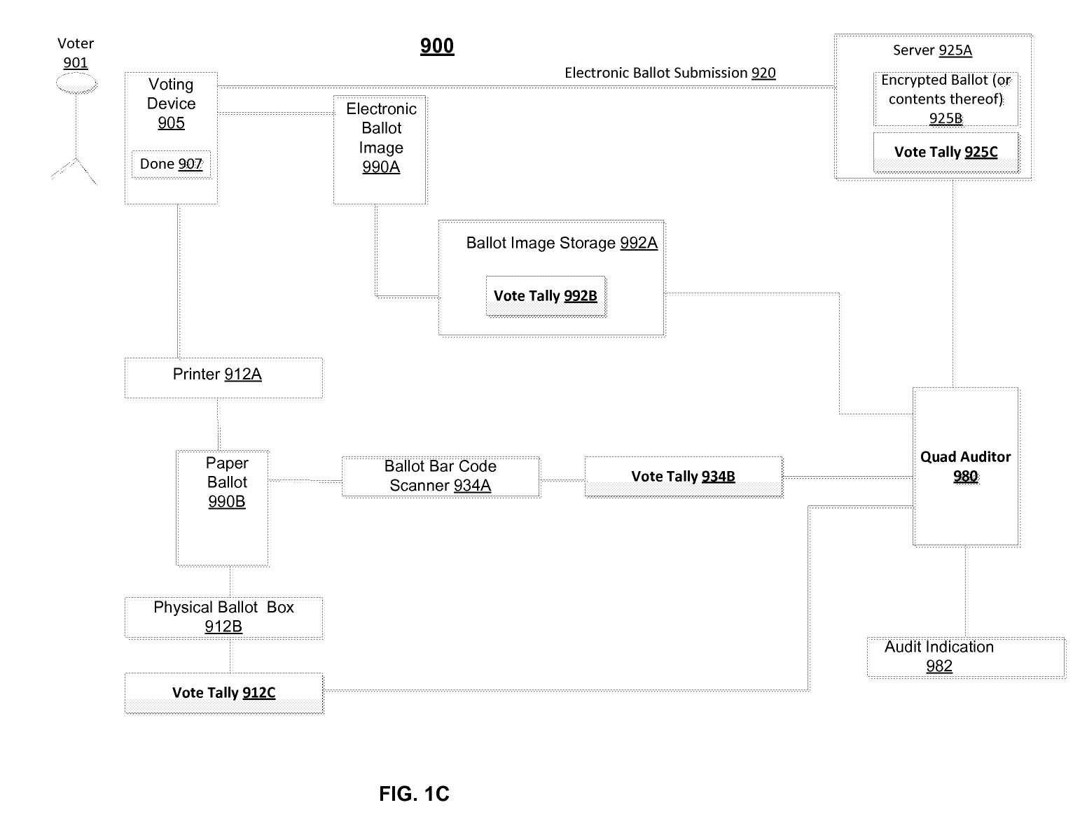

FIG. 1A depicts a system 999, in accordance with some example implementations. A voter 901 may approach a voting device 905. For example, voter 901 may be a voter, such as an absentee voter, casting a vote electronically via a voting device 905 (for example, a computer coupled to a network, such as the Internet, a public land mobile network, an intranet, and/or any other network or link), or the voter 901 may be casting a vote at a polling station including one or more voting devices.

The voting device 905 may be implemented as a device at which a voter may select one or more candidates, one or more propositions, and/or make any other selections. In some implementations, voting device 905 may be implemented as a processor-based device, such as a computer, a tablet, a smartphone, and/or any other processor-based device). The voting device 905 may also include memory, a user interface 990B, such as a browser or other client application, for viewing an electronic ballot 990A and/or making selections on the ballot 990A, and of the like.

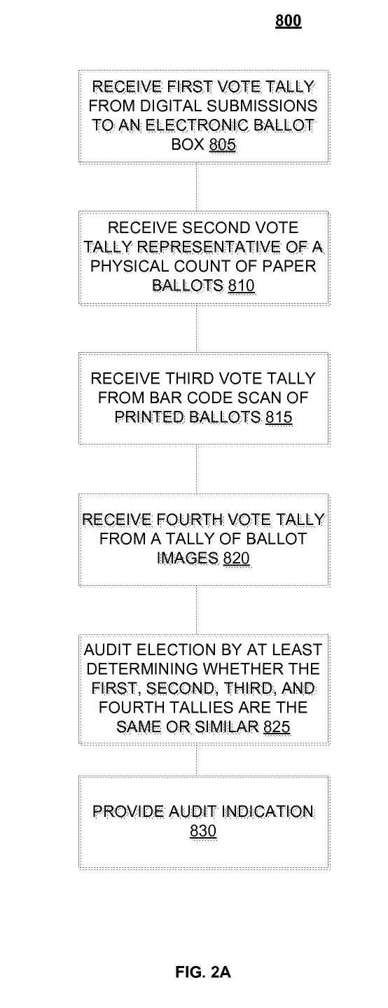

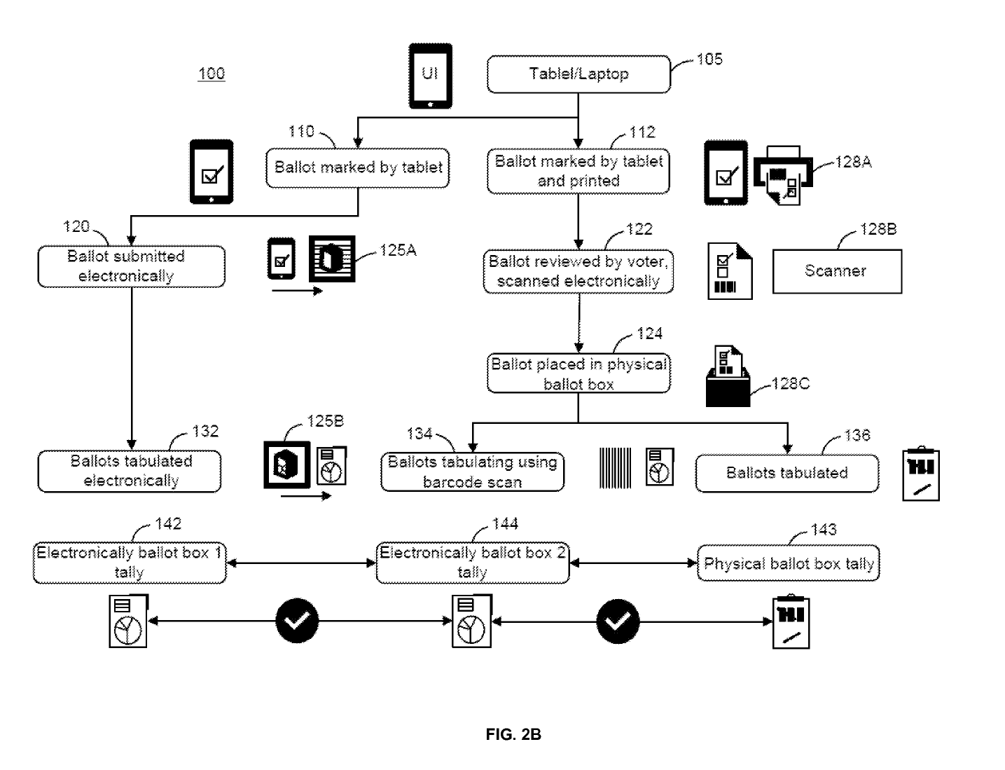

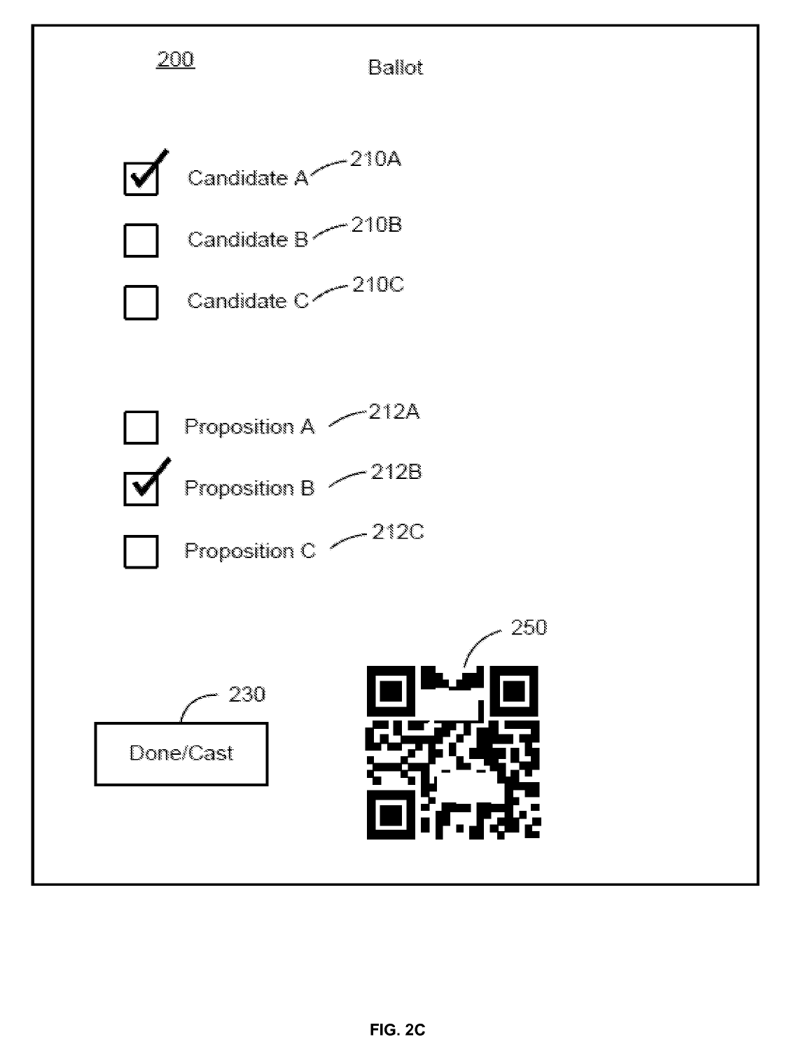

Voter 901 may vote for one or more items (for example, candidates, propositions, initiatives, and the like) on electronic ballot 990A. FIG. 2C described further below depicts an example of an electronic ballot 990A presented by user interface 990B. The check marks in the example of FIG. 2C depict selections made and/or presented at user interface 990B The electronic ballot 990A may in some implementations represent an electronic document defined in a markup language, such as hypertext markup language, HTML 5, XML, and/or any other format or language.

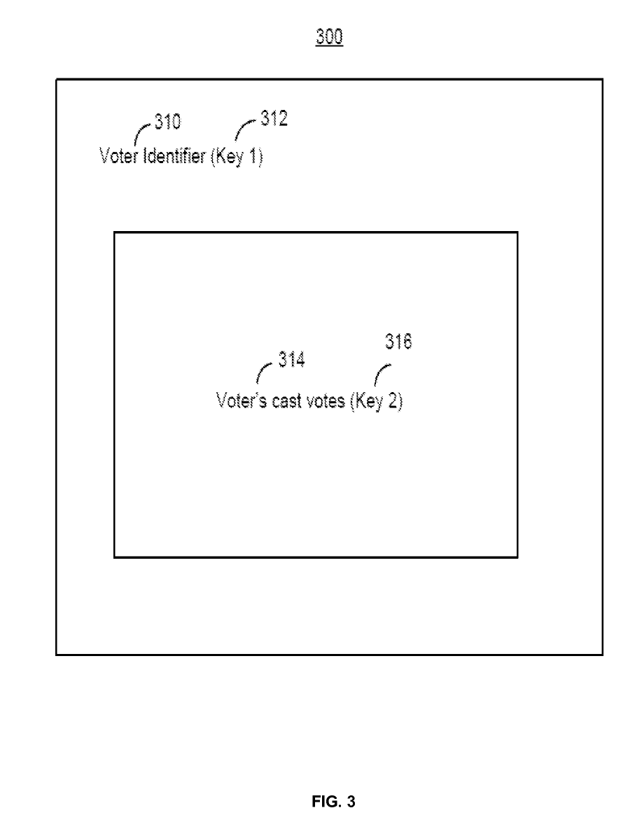

When voter 901 makes a selection of for example a candidate on the electronic ballot 990A and submits the selection for tallying, image renderer 969A may interpret electronic ballot 990A including any selections and render the electronic ballot 990A as for example an image (for example, a png file or other type of image file). The client-side rendering performed by image renderer 969A may generate the image without accessing another server or device. Next, encryption 969B may encrypt the generated image of the electronic ballot 990A. For example, the image may be encrypted by encryption 969B using the Advanced Encryption Standard (AES), although other encryption types may be used as well. The encrypted ballot image 969C may then be sent electronically (for example, via a communication mechanism, such as the Internet, an intranet, and/or any other link, network, bus, and the like) to a server, such as ballot image storage server 992A, a voting server, and the like. Server 992A may then store the encrypted ballot image 969C with other voting information to enable performing vote tallies, audits, and/or other operations. The encrypted ballot image 969C may also be decrypted by decryption 969D. In some implementations, encryption and decryption may be performed using a plurality of keys to protect different portions of the ballot, as described further below with respect to FIG. 3.

FIG. 1B depicts a process 899 which may in some implementations, prevent, or reduce the likelihood of success of, a man-in-the-middle attack by rendering the electronic ballot image at a client voting device, rather than having client voting device/user interface send voting information/selections to a server, which then renders an image of the ballot and then returns the server-rendered-image to the client voting device/user interface. The description of FIG. 1B also refers to FIGS. 1A and 2C.

When a voter submits an electronic ballot at 870, the electronic ballot may be interpreted at 872. For example, when selections are made via user interface 990B, the selection made with respect to the electronic ballot 990A can be submitted for tallying with other cast votes. When this is the case, user interface 990A may receive, in response to for example selecting done/cast at 230 at FIG. 2C, an indication that the voter has cast or submitted the votes.

When selections have been submitted, user interface 990B including image rendering 990B may interpret, at 872, an electronic document representative of the electronic ballot 990A including the selections. For example, user interface 990B including image rendering 990B may interpret an electronic document representative of the electronic ballot 990A submitted at 870. This interpretation may include parsing the electronic document, applying styles, and laying out the document to be rendered.

At 874, the electronic ballot may be rendered as an image. For example, user interface 990B including image rendering 990B may generate an image, such as a png formatted file, and/or any other image file, from the interpreted electronic document representing the electronic ballot including selections submitted at 870.

At 876, the encryption 969 may encrypt the image rendered at 874. For example, the encryption 969 may use AES and/or any other form of encryption to encrypt the image of the ballot rendered at 874 before sending the encrypted ballot image to server 992A via a network.

Table 1 includes an example implementation of computer code which may be used to render the ballot image at the client voting device. Referring to Table 1, a method may be called when for example a voter is reviewing the electronic ballot at a display and the voter is ready to send (or submit) the voting selections to a voting server, such as server 992A. For example, when a user/voter clicks on the send/submit vote, the client voting device may generate an image of a some (or all of) the display presenting the electronic ballot (for example, a PNG bitmap is populated in the data). The called method at Table 1 may then create a session_hash using for example a SHA-256 hash. This hash may be based on the voter's entered credentials_csv and voter identification information. The session_hash may then be concatenated to the generated PNG image (or bitmapped image). Next, 1024-bit RSA encryption may be used to encrypt the session_hash and generated image. The encryption may use a key, such as a public key embedded in the electronic ballot. The encrypted image is then sent securely to a server, such as server 992A (or any other secure server).

TABLE 1
---BEGIN Everyone Counts, Inc. summary page header ---
<script type=“text/javascript” src=“/js/feedback.js”></script>
<script type=“text/javascript”>

var publicKey = “election_public_key”;

$(function( ){
Feedback({

h2cPath: “/js/html2canvas.js”

});

});

</script>
---END---
---BEGIN Everyone Counts, Inc. modified [feedback.js]---
<script src=“/js/lib/sha256.js”></script>
<script src=“/js/lib/jsencrypt.min.js”></script>
...

window.Feedback = function( options ) {

// Set display labels and forward to stage two of modified feedback.
options.label = options.label || “Encrypt Ballot Image In Browser”;
options.header = options.header || “Image now encrypted”;
options.nextLabel = options.nextLabel || “Send Encrypted Ballot Image to Server”;
options.messageSuccess = options.messageSuccess “Encrypted ballot image sent successfully.”;
options.messageError = options.messageError || “There was an error sending your encrypted ballot image to

the server.”;

currentPage = 2;
...

}

---END---
---BEGIN Everyone Counts, Inc. modified [feedback.js]---

send: function( ) {

var resultDiv = $(“#resultDivContainer”);
$.ajax({

url: “https://election.everyonecounts.com/quad-audit/”,
type: “POST”,
data: { apiKey: “voterKey”, method: “set-enrypted-image”, ip: “208.74.35.5” },
dataType: “json”,
success: function (result) {

switch (result) {

case true:

processResponse(result);
break;

default:

resultDiv.html(result);

}

},
error: function (xhr, ajaxOptions, thrownError) {

alert(xhr.status);
alert(thrownError);

}

});

---END---
---BEGIN Everyone Counts, Inc. modified [feedback.js]---
send: function( ) { }

label: “”,
blackoutButton = element(“a”, “”),
highlightButton = element(“a”, “”),
this.dom.appendChild( element(“p”, “”) );
...

---END---
---BEGIN Everyone Counts, Inc. modified [feedback.js]---
// voter_id and credentials_csv are obtained via voter login form.
var session_hash = CryptoJS.SHA256(voter_id + credentials_csv)
var crypt = new JSEncrypt( );
crypt.setPublicKey($(‘#publicKey’).val( )); // publicKey is defined in our eLect page header.
xhr.open(“POST”, this.url, true);
var image = data[1]; // data was populated by the caller, not defined by us.
xhr.send( encodeURIComponent( crypt.encrypt(session_hash + image) ) );
---END---
---BEGIN Everyone Counts, Inc. EncryptedImage.pm handler---
sub handler : method {

my $self = shift || return(Apache2::Const::NOT_FOUND);
my $r = shift || Apache2::RequestUtil−>request;
my $uri_loc = $r−>dir_config(‘URIStub’);
my $ret_code = 200;
my $insert_ok = 0;
my $decoded = “;
# Read JSON content from POST.
my ($buf, $content);
my $content_length = $r−>headers_in( )−>get(‘Content-Length’) || 0;
if ($content_length) {

while( $r−>read($buf, $content_length) ) {

$content .= $buf;

```
  }
  my $encoded_encrypted_image = uri_unescape($content);
  $encoded_encrypted_image =~ s{\[object Object\],data:image/png;base64,}{ };
  $encoded_encrypted_image =~ s{data:image/png;base64,}{ };
  my $encrypted_image = MIME::Base64::decode_base64( $encoded_encrypted_image );
  my $save_quad_audit_image_sql = ‘INSERT INTO tblCurrentSubmissionContent (Submission) VALUES
```

(?)’;

```
  my $sth = $dbh−>prepare($save_quad_audit_image_sql);
  eval { $insert_ok = $i_sth−>execute($encrypted_image) };
  if (! $insert_ok) {
```

$self−>dprint(‘Error saving quad-audit encrypted image: ‘ . $dbh−>errstr, 1);
$dbh−>rollback;
$ret_code = 500;

}

}
$r−>content_type(‘text/plain’);
$r−>no_cache(1);
$r−>headers_out−>set(‘Expires’, ‘now’);
$r−>status($ret_code);
return Apache2::Const::OK;

}
---END---

In some example implementations, the electronic ballot images rendered at the client voting system may be used with auditing mechanisms. For example, the electronic ballot images may be used to audit election results obtained from other sources processed via a plurality of voting channels. A single voting channel may refer to a single process including making selections to vote for a candidate, proposition, and the like, casting ballots including the selections, accumulating the results of the cast ballots in a ballot box (for example, a storage mechanism), and tabulating the results from the ballot boxes. If the same ballots are disseminated via a plurality of voting channels, the results from each of the voting channels and/or ballot boxes should be about the same. Otherwise, there may be a discrepancy which may require investigation, a recount, and/or some other action.

FIG. 1C depicts a system 900, in accordance with some example implementations. A voter 901 may approach a voting device 905. The voting device 905 may be implemented as a device where a voter may select candidates, propositions, and/or make any other selection. In some implementations, voting device 905 may be implemented as a processor-based device. When this is the case, voter 901 may vote electronically at the voting device 905, which may comprise a computer, a tablet, a smartphone, and/or any other processor-based device. For example, the voter 901 may be a voter, such as an absentee voter, casting a vote electronically via a computer coupled to a network (for example, the Internet, a public land mobile network, an intranet, and/or any other network or link), or the voter may be casting a vote at a polling station, which may include one or more processor-based voting devices where a voter may cast a vote.

The voter 901 may vote for one or more items (for example, candidates, propositions, initiatives, and the like). FIG. 2C described further below depicts an example of a ballot 200 including the selections (which are indicated by check marks) which may be presented on a display coupled at the voting device 905. Referring again to FIG. 1, when the voter 901 is done making selections, the voter may cast the vote. In some implementations, the voter 901 may be presented with an image of the selections (for example, a printed paper ballot with the selections made by the voter or an image of those selections presented electronically on a display) in ballot form, as depicted at for example FIG. 2C, at ballot image 990A. For example, the voter selections 990A may be presented as a way for the voter to visually audit the selections made at voting device 905. If the voter 901 believes the presented ballot image 990A accurately captured the voter's selections made at voting device 905, the voter 901 may select done at 907 (or 230 at FIG. 2C) to cast the vote including for example the one or more selections made at 905. However, if the voter 901 believes the selections presented are not accurate, this error may be reported to quad auditor 980 to flag a possible issue with the election process. For example, if the voting machine is hacked or otherwise compromised, a voter's 901 selection may be modified by the malicious code and modified, which may be detected during the presentation of ballot image 990A. Moreover, if quad auditor 980 detects a polling station or voting device having a high frequency of errors detected by voters while reviewing the ballot image at 990A before casting the ballot, the auditor 980 may flag the polling station for further auditing. And, in some implementations, the completed and visually audited ballot image (for example, ballot 200 at FIG. 2C) from voting device 905 (as well as other voting devices) may be stored at an image storage server 992A as an image to enable tallying from the stored images the votes at 992B. Furthermore, this image be encrypted and/or wrapped in a digital signature to enhance the integrity of the stored ballot image.

In some implementations, the completed and cast ballot may be submitted electronically at 920 to another device, such as for example a server 925A. For example, the server 925A may be coupled to voting device 905 via a communication mechanism, such as for example a network (for example, a local area network, the Intranet, a wireless network, and/or a combination thereof), a link, a bus, and/or the like. Some (if not all) of the contents of the electronic ballot (for example, the selections made, a ballot identifier identifying the ballot type used, a session identifier identifying the voting session used at voting device 905, user identification information, and/or other information) may be encrypted before being sent at 920 to server 925A, although the encryption may take place at other times as well (for example, encryption may be performed when received by server 925A). The encryption ballot 925B may be stored at server 925A. Rather than contain an electronic image of the ballot, the electronic ballot submitted at 920 may, in some implementations, represent, as noted above, the contents of electronic ballot (although the image of the ballot may be included as well). Furthermore, the encryption of the electronic ballot 925B may secure all or a portion of the contents of the ballot. For example, the encryption may protect one or more of the voter's identity, selections made, and session identifier identifying the voter's voting session at voting device 905. In addition, different keys may be used. For example, a first key may be used to protect the selections made, and a second key may be used to protect the voter's identity. In this example, the voter's identity can be separately protected/secured to enhance the anonymity of the voter. At 925C, the server 925 may tally one or more of the ballots (for example, ballot 925B and the like) electronically submitted by voting device 905 as well as other voting devices.

In some implementations, when voter 901 selects done at 907 to cast the vote (for example, the one or more selections made at 905), the ballot may be printed by printer 912A. The printer 912A may be a standard computer printer, a high-quality printer used to print ballots for elections, and/or any other type of printer. The printed paper ballot 990B may, in some example, implementations include a bar code. This bar code may be used to encode some if not all of the contents of a ballot. For example, a bar code or other machine readable medium may encode the selections made at the ballot and the ballot type (an identifier indicating the type of ballot used to make the selections), so scanning the bar codes of ballots counts the selections made at each ballot. The paper ballot 990B may be submitted to a physical ballot box at 912B for subsequent vote tally at 912C of the paper ballots submitted and printed from voting device 905 as well as other voting devices.

The printed paper ballot 990B may, in some example, implementations, also be scanned using a ballot scanner 934A. The ballot scanner 934A may be a standard computer scanner, a high-quality scanner used to scan election ballots, and/or any other type of printer. In some implementations, ballot scanner 934A may scan a bar code printed on the paper ballots to determine the votes cast on paper ballots, although the scanner may also detect the marks made on the ballots themselves (for example, check marks, bubbles, and/or the like made on the ballots). At 934A, a computer-based processor may tally the scanned votes cast by voting device 905 as well as other voting devices and then printed 912A and scanned at 934A.

In some implementations, quad auditor 980 may receive vote tallies from the physical ballot box vote tally 912C (which may represent a first voting channel), the stored ballot image tally 992B (which may represent a second voting channel), the electronically submitted vote tally 925C (which may represent a third voting channel), and the bar code scanned vote tally 934B (which may represent a fourth voting channel). If there the vote tallies from 912C, 992B, 925C, and 934B are the same, then quad auditor 980 may indicate that the election results are true. However, if the election results differ, the quad auditor 980 may indicate a discrepancy in the results (which may require additional auditing to determine the source of the discrepancy).

FIG. 2A depicts an example process 800 for auditing election results in accordance with some example implementations.

At 805, the quad auditor 980 may receive a vote tally representative of electronic ballot submission stored at server 925A. For example, server 925A may store one or more ballots (or the contents thereof), such as ballot 925B and the like. The server 925A may also tally the selections made via each ballot. For example, the server 925 may tally the quantity of votes for candidate A and tally the quantity of votes for candidate B, and send the tallies 925C to quad auditor 980.

At 810, At 805, the quad auditor 980 may receive a vote tally representative of physical ballots printed by printer 912A and stored at ballot box 912B. For example, the ballots at ballot box 912B may be counted in a variety of ways, and the vote count for the selections made at the ballots stored at ballot box 912B reported as a vote tally 912C to quad auditor 912C. This reporting may be performed in a variety of ways, such as email, message, or other indication, sent to quad auditor 912C. For example, the vote tally 912C may be sent via a message to quad auditor 980 to report the quantity of votes for candidate A and the quantity of votes for candidate B.

At 815, the quad auditor 980 may receive a vote tally representative of ballots scanning of bar codes on the ballots. For example, paper ballots 990B may be scanned via ballot bar code scanner 934A to determine the selections made on the ballots. For example, scanning may determine the quantity of votes for candidate A and the quantity of votes for candidate B, and send those quantities as vote tally 934B to quad auditor 980.

At 820, the quad auditor 980 may receive a vote tally representative of ballot images. For example, images of ballots, such as ballot 200 and the like, may be stored at image storage server 992A, and the selections made at each of the ballot images may be accumulated at vote tally 992B. For example, vote tally 992B may represent the quantity of votes for candidate A and the quantity of votes for candidate B. The vote tally 992B may be sent to quad auditor 980.

At 825, quad auditor 980 may compare the vote tallies received at 805-820 to determine whether the tallies are the same or different. For example, if the vote tallies are the same, then quad auditor 980 may determine that the election results reported via each of the voting channels is likely to be true. When this is the case, quad auditor 980 may send an indication, such as a message, to a user interface and the like to indicate at 930 that the reported voting results provided at 805-820 are true. However, if the vote tallies are not the same, then quad auditor 980 may determine that further auditing of the election results reported via each of the voting channels should be performed to determine the source of the discrepancy. When this is the case, quad auditor 980 may send an indication, such as a message, to a user interface and the like to indicate at 930 that the reported voting results provided at 805-820 may require additional auditing to determine the source of the discrepancy. This discrepancy may result in additional investigation into the provenance of the election results and the corresponding processing of via each of the channels to identity the cause of the discrepancy.

FIG. 2B depicts another example process 100 for auditing voting results from a plurality of voting channels.

At 105, a voter may access a processor-based device, such as for example a computer, a tablet computer, a smart phone, and the like. The processor-based device may include a user interface for presenting a view or a page (for example, a hypertext markup language page and the like) containing a ballot. The ballot may include graphical elements that can be selected by the voter in order during the voting process. The processor at 105 may be located at a polling place as well as any other location, such as for example a user's work, home, and the like.

FIG. 2C depicts an example of a ballot 200, which may be presented at the processor during 105. Ballot 200 may include graphical elements 210A-C and 212A-C presented at the user interface of the processor. These graphical elements may be configured to allow a voter to select one or more of graphical elements 210A-C, 212A-C to indicate a vote for a candidate, a proposition, and the like. For example, a selection may be made by hovering over graphical element 210A, a mouse click over graphical element 210A, making contact with a touch screen at location corresponding to graphical element 210, and the like to select Candidate A as shown by the check mark. The voter may also select Proposition B as shown by the check mark at 212B. Once the voter is done, the voter may select graphical element 230 to indicate completion and thus cast, print, send, and/or deposit the vote. The voting selections, which in this example correspond to selections Candidate A and Proposition B, may be encoded in a machine readable graphical element, such as for example a bar code, a two dimensional bar code, and/or in another mechanism, such as for example a magnetic strip, a radio frequency identifier, an alpha or numeric code, and the like. In the example of FIG. 2C, a two dimensional bar code 250 encodes the selections of Candidate A and Proposition B.

Referring again to FIG. 2B, the voter may mark, at 110, the ballot electronically using the processor-based device, and this processor may provide (for example, via a communication link) the ballot electronically to a storage mechanism, such as for example a database and the like. This storage device may provide a so-called “electronic ballot box.” At 132, the ballots stored at the storage device may also be tabulated electronically at 132. For example, all of the ballots stored at the storage device 125A may be accessed and tallied to determine voting results. In this example, the process of marking at 110, submitting the ballots electronically at 120, storing the ballots at storage 125A, and tabulating the ballots electronically at 132 may be considered a voting channel. The quad auditor may receive the voting results from storage device 125A in order to compare the results during an audit of the ballot boxes.

At 112, the voter may mark the ballot electronically on the processor, and the processor may forward the ballot to a printer 128A via a communication link, such as for example a network and the like. The printed ballot may be similar in some respects to ballot 200 and include one or more of the graphical elements 210A-C and 212A-C and the bar code 250.

At 122, the printed ballot may be reviewed by the voter, and then submitted for scanning by a scanner 128B. For example, a user, such as for example a voter, may review the printed ballot, and if the voter chooses to cast the ballot, it is provided to scanner 128B. At 124, the printed ballot may also be placed in a physical ballot box 128C. At 134, the scanned ballots may be stored in a storage mechanism 128D, such as for example a database and the like, and then tabulated to determine results. For example, the scanned ballots from one or more voters may be tabulated by decoding the bar codes, such as for example bar code 250, having the results of each vote cast. The paper ballots placed in the physical ballot box at 124 may also be tabulated using other mechanisms as well (for example, manually tabulated, checking tallies stored at the processor itself to determine counts of votes cast at 105, and the like). In this example, the process of marking at 112, submitting the ballots electronically at 122, and tabulating the ballots based on the bar codes at 134 may be considered a voting channel. And, the process of marking and printing the ballots at 112, placing the ballots in a physical ballot box at 124, and the tabulating the ballots at 136 may be considered a voting channel as well. The quad auditor described herein may receive the voting results obtained from the tabulated bar code and the tabulated results from the physical ballot boxes.

At 142-146, the ballots tallied electronically at 132, tabulated using the bar code at 134, and tabulated using other mechanism at 136 may be compared. For example, the quad auditor (which is also referred to herein as a controller) may be coupled via communication links to the electronic ballot boxes and/or other processor in order to obtain the ballots tallied electronically at 132, tabulated using the bar code at 134, and tabulated using other mechanisms at 136. The quad auditor/controller may then compare the results. In this example, the ballots tallied electronically at 132, tabulated using the bar code at 134, and tabulated using other mechanisms at 136 should be substantially similar, if not the same. For example, the voting results for the ballots tallied electronically at 132, the ballots tabulated using the bar code at 134, and the ballots tabulated using other mechanisms at 136 (for example scanned ballot images, physical ballots, and the like) should be about the same as each of the voting channels are based on the same original ballots cast at the user interface at 105. The quad auditor may report to another processor via email and the like whether the voting results for the ballots tallied electronically at 132, the ballots tabulated using the bar code at 134, and the ballots tabulated using other mechanisms at 136 are indeed the same (or similar). If the quad auditor determines a substantial difference, the discrepancy may be reported by the quad auditor. For example, the quad auditor may generate a report indicating whether the results from the different ballot boxes are similar or the same and then send the report as a message via email or other communications medium.

When the ballot is sent electronically from one device to another device, the ballot may be encrypted in accordance with some exemplary implementations. For example, when the processor sends ballot 200 to a storage device at 125A, the voter's ballot 200 may be encrypted. Moreover, in some exemplary implementations, the voter's identity, such as for example a name, an address, and the like, may be encrypted using a first key and the voter's selections on the ballot 200 may be encrypted using a second key. The first and second keys may be configured in accordance with a public key infrastructure and may include private and/or public keys, although other types of encryption techniques may be used as well. Furthermore, the first and second keys may be implemented as the same key. Moreover, in some implementations, no encryption or a very weak encryption, such as for example a coding scheme, may be used as well.

FIG. 3 depicts an example of a ballot encrypted at 314 using a second key 316, and the voter's identity 310 encrypted with another key 312. In implementations using two keys, one key is used for the voting selections and another key is used for the voter's identity. As such, the voter's identity 310 may be kept private (for example, remain encrypted) when the voter's results 314 are deciphered and read in order to tabulate the vote. For example, the voting selections at 314 may be decrypted without decrypting the voter's identify 310, and, similarly, the voter's identify 310 may be decrypted without deciphering the voting selections 314.

In some implementations, the two key mechanisms noted above may allow identifying votes cast which are ineligible and re-tabulating the results, while maintaining voter privacy. For example, after a vote is cast, it may be determined that the voter was not eligible to vote (for example, a convicted felon, an unregistered voter, and/or any other type of ineligible voter). In this example, the improperly cast vote may be searched for in a storage mechanism, such as for example an ballot box, and then identified using the voter identifier 310 by deciphering the voter identifier, and then retracting the voting results 314 for that ineligible voter, without decrypting the voting results 314 for that ineligible voter, maintaining thus the privacy of the voter.

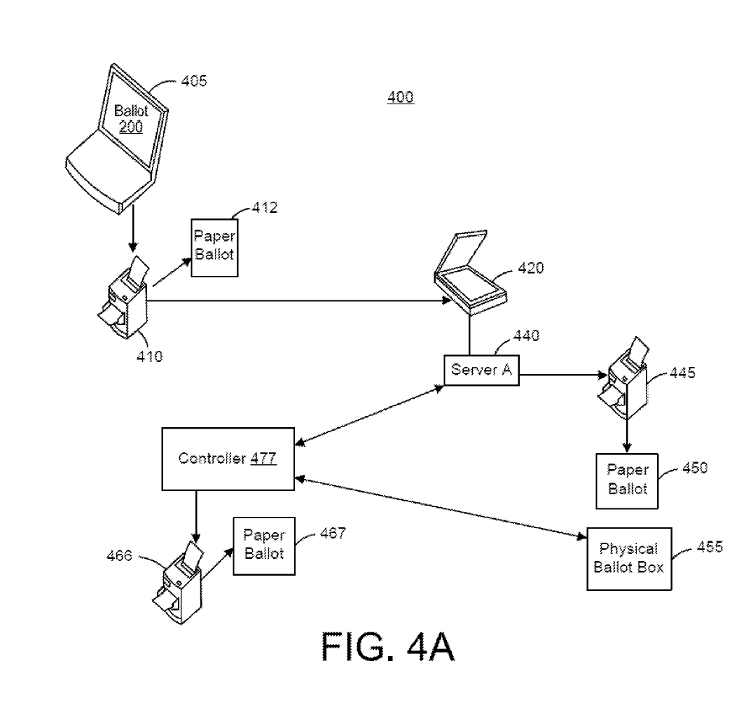

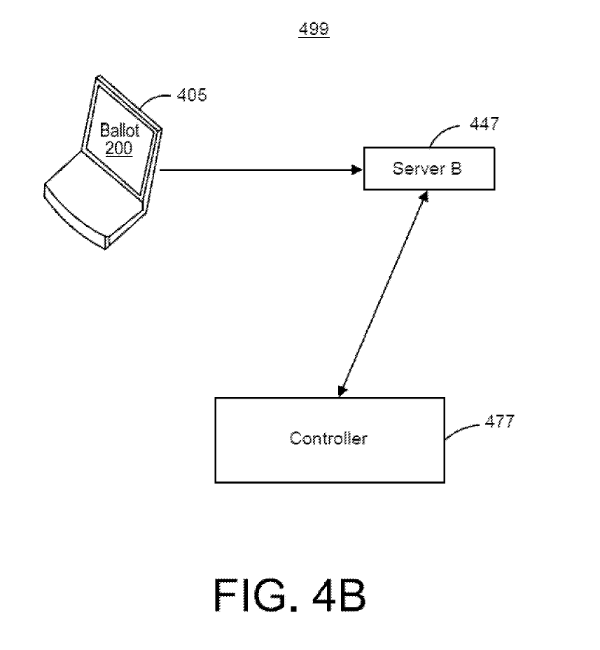

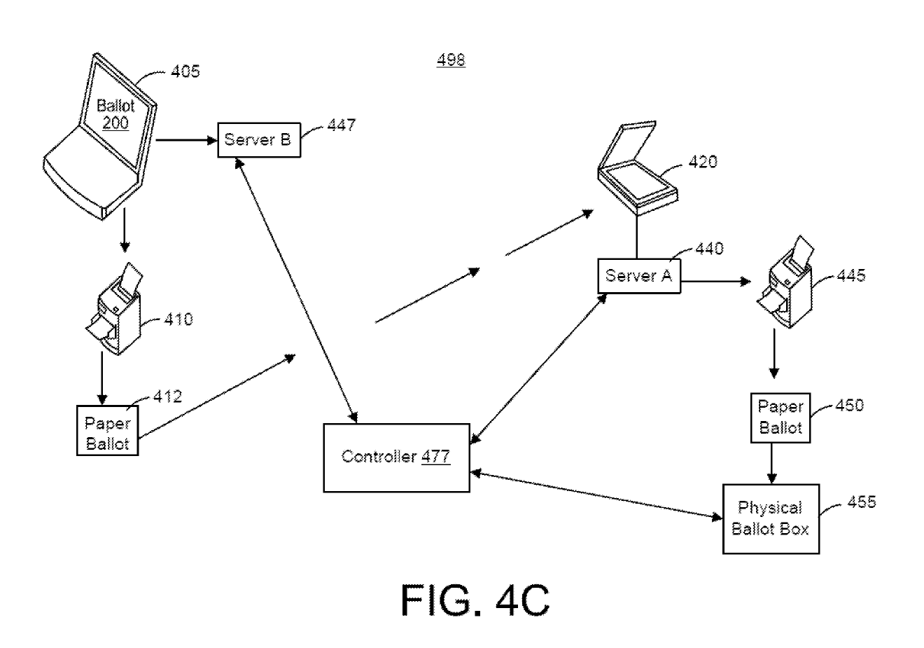

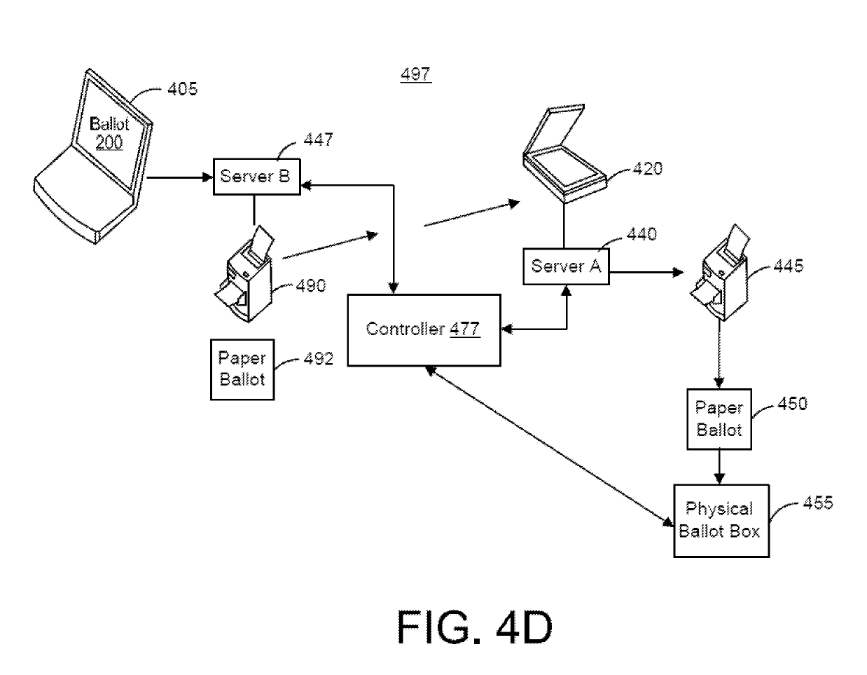

FIGS. 4A-4D depict additional examples of voting channels.

FIG. 4A depicts a system 400 including a processor 405, such as for example a tablet, a smart phone, a computer 405, and the like. The processor 405 may present a ballot, such as for example ballot 200, so that the user can vote by making a selection (for example, by hovering over with a mouse and selecting graphical elements, such as for example 210A-C and 212A-C, touching a touch screen to select the graphical elements, and the like). When the user (also referred to as a voter) is done making selections, the ballot 200 may be sent to a printer 410, where a paper ballot 412 is printed. The paper ballot 412 may include the voter's selections in a format which is readable by the voter (for example, as text) and/or readable by a machine, such as for example a barcode. The printed ballot as well as other ballots may be scanned at scanner 420 and the scanned ballots may be sent (for example, via a communication link, such as for example a network) to server A 440 for storage. A processor may encrypt the ballots before sending the ballots to server A 440. The server A 440 may comprise a database and may be referred to as electronic ballot box holding a plurality of ballots from voters. The results at server A 440 may be tabulated to determine a value representative of the voting results. Moreover, the ballots in the server A 440 may also be sent to a printer 445, which may print physical, paper ballots 450. These paper ballots may also be accumulated in another ballot box, such as for example physical ballot box 455.

In some implementations, the processor 405 may include a computer-readable storage medium, which can be accessed directly to determine the results of the voting (for example, vote totals, counts, etc.). And, the voting results can be accessed at any time (for example, during the original vote count and/or during a recount), and the voting results can be accessed separately from the voting results stored at other locations, such as for example server A 440, ballot box 455, and the like.

In this example, a quad auditor (also referred to herein as controller) 477 may be coupled to server A 440 and receive tabulated results from the ballots stored therein. Controller 477 may also couple to other devices, such as for example processor 405, and may couple to a printer 466 where ballots 467 may be printed as well (for example, during the original vote count as part of the auditing and/or during a recount and associated audit). Controller 477 may also receive an indication of the voting results tabulated from physical ballot box 455 (for example, the physical ballots may be manually tabulated and/or tabulated electronically and the results sent via a message, an email and the like to controller 447). In this example, controller 477 may compare the results from server A 440, physical ballot box 455, and other sources (for example, one or more processors, such as for example processor 405 which may keep a count of the voting results for auditing). If controller 477 determines a difference in the results, the discrepancy may be reported by controller 477 by, for example, sending a message to an email address or other communications medium indicating the results of the audit. If the controller 477 determines the results from server A 440 and physical ballot box 455 are the same (or substantially similar), the controller 477 may also report that the audit confirmed the veracity of the results.

To illustrate further, a voter may access processor 405 at a polling place, at home, and/or at any other location. Once the ballot 200 is completed, the ballot can be printed at 410 at a polling place, at home, or at any other location. For example, a voter may print the ballot 200 and provide the ballot 200 to a voting official at a polling place. The voter may also print the ballot at home (or at any other location) and mail (or otherwise provide) the ballot to voting officials, although other printing options may be implemented as well.

FIG. 4B depicts a system 499 including processor 405 presenting ballot 200, so that the user can vote by making selections on the ballot. When the user/voter is done making the selections, processor 405 may send ballot 200 electronically to a server B 447. For example, processor 405 may be coupled to server B 447 via a communication link, such as for example a network, the Internet, an intranet, and/or any other link, to server B 447. In this example, processor 405 may send the ballot 200 as a message, an email, and the like to server B 447. Moreover, processor 405 may send the ballot 200 encrypted, and the encryption may use a plurality of keys as described with respect to FIG. 3, although the ballot 200 may be sent in plaintext (i.e., unencrypted) as well. The server B 447 may include a database for storing the ballots, and the server B may also be referred to as an electronic ballot box. The server B 447 and/or database storing the ballots may tabulate the results. In some implementations, the server B 447 may decrypt the voting results in order to tabulate the results, while in other implementations, the server B may store the results in an encrypted form and tabulated in an encrypted form (for example, using a zero knowledge proof technique).

In the example of FIG. 4B, controller 477 may be coupled to server B 447 and receive tabulated results from the ballots stored therein. The controller 477 may audit the tabulated results by comparing the tabulated results to other the results from other ballot boxes.

FIG. 4C depicts a system 498 including processor 405 presenting ballot 200, so that the user can vote by making one or more selections. When the user/voter is done making selections, the ballot may be sent electronically to server B 447, where it may be stored. The ballot may also be sent to a printer 410, which may print the ballot 412. The paper ballot 412 may include the voter's selections in a format which is readable by the voter and/or readable by a machine. The printed ballot 412 and any other ballots may be scanned at scanner 420 and the scanned ballots may be sent to a processor, such as for example server A 440 for storage and/or tabulation. The server A 440 may also be configured as an electronic ballot box holding a plurality of ballots from voters. The results at server A 440 may be tabulated to determine a value representative of the voting results. Moreover, the ballots in the server A 440 may also be sent to a printer 445, which may print physical, paper ballots 450. These paper ballots may be accumulated in another ballot box, such as for example physical ballot box 455.

In the example of FIG. 4C, controller 477 may be coupled to server B 447 and server A 440, and receive tabulated results from the ballots stored at those servers/electronic ballot boxes. Controller 477 may also receive an indication of the voting results tabulated from physical ballot box 455 (for example, a user may send the results via email, text message, and/or other electronic mechanisms to controller 477). In this example, the controller 477 may compare the results from the electronic ballot boxes (for example, server A 440 and server B 447) and physical ballot box 455 to audit the voting results. If the controller 477 determines a substantial difference, the discrepancy may be reported by controller 477 by, for example, sending a message to an email address or other communications medium indicating the results of the audit. If the controller 477 determines the results from server A 440 and physical ballot box 455 are about the same, the controller 477 may also report that the audit confirmed the veracity of the results. For example, the results from each of the ballot boxes may be 1000, 1000, and 1000, so in this example, the controller 477 may report the veracity of the results as true and indicate no detected problems. However, the controller 477 may include a predetermined threshold defining what difference is considered meaningful with respect to reporting. For example, the results from each of the ballot boxes may be 1000, 1001, and 999, so in this example, the controller 477 may be configured to have a threshold value of 5 which means differences of 5 or less may be considered insubstantial, so the controller 477 may still report the veracity of the results as true and indicate no detected problems.

To illustrate further, a voter may access processor 405 at a polling place, at home, and/or at any other location. Once the ballot 200 is completed, the ballot may be sent to server B 447 and/or printed at 410 at a polling place, at home, or at any other location, as noted above.

FIG. 4D depicts a system 497 including processor 405 presenting ballot 200, so that the user can vote by making one or more selections. When the user/voter is done making selections, the ballot 200 may be sent electronically to a server B 447 via a communication link, such as for example a network and the like. The server B 447 may store the ballots in a database, where the voting results from ballots can be tabulated. The ballots at server B 447 may also be sent to a printer 490, which prints ballot 492. The paper ballots 492 may include the voter's selections in a format which is readable by the voter and/or readable by a machine. The printed ballots 492 may be scanned at scanner 420, and the scanned ballots may be sent via a communication link to server A 440 for storage. The servers A 440 and B 447 may be referred to as an electronic ballot box holding a plurality of ballots from voters. The results at server A 440 may also be tabulated to determine a value representative of the voting results. Moreover, the ballots in the server A 440 may also be sent to a printer 445, which may print physical, paper ballots 450. These paper ballots may be accumulated in another ballot box, such as for example physical ballot box 455.

In the example of FIG. 4D, controller 477 may be coupled to server B 447 and server A 440, and receive tabulated results from the ballots stored at those servers/electronic ballot boxes. Controller 477 may also receive an indication of the voting results tabulated from physical ballot box 455. In this example, the controller 477 may compare the results from the electronic ballot boxes (for example, server A 440 and server B 447) and physical ballot box 455 to audit the voting results. Moreover, the controller 477 may determines whether there are any differences in the voting results from the different ballot boxes. If there is a substantial difference, the discrepancy may be reported by controller 477 by, for example, sending a message to an email address or other communications medium indicating the results of the audit. If the controller 477 determines a the results from server A 440 and physical ballot box 455 are about the same, the controller 477 may also report that the audit confirmed the veracity of the results.

Controller 477 may be implemented as at least one processor including a computer-readable storage medium. Moreover, the controller 477 may couple (for example, via the Internet, an intranet, and the like) to one or more other devices to control, monitor, configure, manage, audit, one or more aspect of the voting process disclosed herein.

The devices disclosed herein may be coupled via communication links and/or networks, examples of include, alone or in any suitable combination, the Internet, a telephony-based network, a local area network (LAN), a wide area network (WAN), a dedicated intranet, wireless LAN, an intranet, a wireless network, a bus, or any other communication mechanisms. Further, any suitable combination of wired and/or wireless components and systems may provide the communication link(s). Moreover, the communication link(s) may be embodied using bi-directional, unidirectional, or dedicated communication links, and may also implement standard transmission protocols, such as for example Transmission Control Protocol/Internet Protocol (TCP/IP), Hyper Text Transfer Protocol (HTTP), SOAP, RPC, or other protocols. For example, the controller 477 may be coupled via the Internet to processor 405.

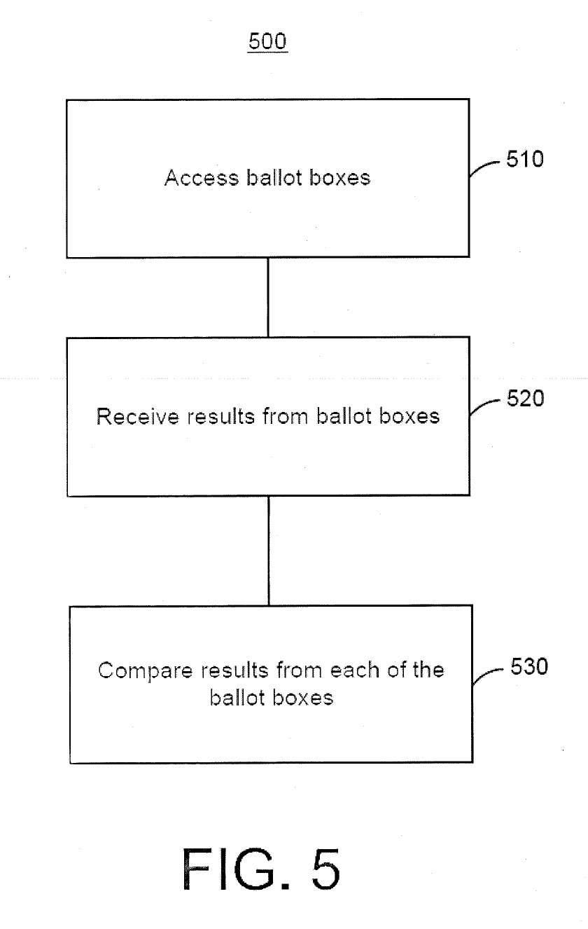

FIG. 5 depicts a process 500 for auditing voting results from a plurality of voting channels including ballot boxes. The description of process 500 also refers to FIGS. 4A-4D.

At 510, the quad auditor/controller may access one or more ballot boxes in one or more voting channels. For example, quad auditor (for example, controller 477) may couple to one or more storage mechanisms, such as electronic ballots boxes at server A 440 and server B 447.

At 520, the quad auditor/controller may receive results from one or more ballot boxes in one or more voting channels. For example, the controller 477 may receive results from server A 440 and server B 447 and an indication of the results from the physical ballot box 455. For example, the returns from the physical ballot box 455 may be tabulated via for example a device, such as for example an optical reader, or a manual tally, and those results may be sent via message (for example, email, etc.) to controller 477.

At 530, the quad auditor/controller 477 may compare the results to determine whether there is a difference between the one or more ballot boxes in one or more voting channels. For example controller 477 may determine whether there is a difference between the results from server A 440, server B 447, and physical ballot box 455. In some implementations, if there is any difference, the controller 477 may report the difference to indicate a problem with the veracity of the results. In some other implementations, if the difference is at, or below, a threshold, the controller 477 may determine the difference as insubstantial and treat the difference as if all the results were the same, so the controller in this example would report the veracity of the results/ballots as being true.

Although FIGS. 1, 2B, and 4A-4D depict certain quantities of processors, scanners, storage devices, and the like, other quantities and configurations of these devices may be used as well.

The subject matter disclosed herein may thus provide a way to audit ballots cast during an election by comparing the count of the same ballots stored/retained in a plurality of ballot boxes, including electronic ballot boxes and/or physical ballot boxes. Under normal conditions, the results/counts from all of the ballot boxes should match exactly. If there are discrepancies, a user can initiate further investigation of the results and to identify the source of the discrepancy.

In some implementation, one version of the results is obtained directly from system(s) being used to mark the ballots and then aggregated after the election. In some other implementations, the systems being used to mark the ballots couple to a central server. In some implementations, the printed ballots are either scanned or optically recognized or a barcode is scanned and used to read the markings into a system that can then tabulate the results. Each scanning system can be connected via network to a centralized system or be independent. A third set of results can be obtained by manually counting the paper ballots or ballot receipts. The results from the various tabulation steps can be compared and verified to match. In the event of a discrepancy, a jurisdiction can decide which version of the results will be the official version.

Without in any way limiting the scope of the claims appearing below, a technical effect of one or more of the example embodiments disclosed herein is providing auditable mechanisms including physical, paper trails for each vote.

In some implementations, the voting data (for example, a voters selection) encoded in the barcode can be encrypted with a cryptographic key. In some implementations, the key may be a system-wide key, although the key may be unique to each user. The key required to decrypt voting data may be stored on the machine performing the scanning function, and the machine can show the voter that their markings were correctly captured in the barcode. In some implementations, the key used to decrypt the barcodes would be loaded into any machines requiring decryption after the voting period is complete or the election is over. In some implementations, the printout from the ballot marking system can include a human-readable portion that would be deposited into the physical ballot box and a receipt portion which can contain a receipt code either in plain text or an encrypted barcode which can be used by the voter after the election to verify that their vote was counted without the voter being able to prove that they voted in a particular way (which would enable vote selling).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor (for example, a processor-based including circuitry and the like), which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example for example as would a non-transient solid-state memory or a magnetic hard drive or any equivalent storage medium. The machine-readable medium can alternatively or additionally store such machine instructions in a transient manner, such as for example for example as would a processor cache or other random access memory associated with one or more physical processor cores.

To provide for interaction with a user, one or more aspects or features of the subject matter described herein can be implemented on a computer having a display device, such as for example for example a cathode ray tube (CRT) or a liquid crystal display (LCD) or a light emitting diode (LED) monitor for displaying information to the user and a keyboard and a pointing device, such as for example for example a mouse or a trackball, by which the user may provide input to the computer. Other kinds of devices can be used to provide for interaction with a user as well. For example, feedback provided to the user can be any form of sensory feedback, such as for example for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as for example single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, at a processor including a user interface, an indication representative of an electronic ballot cast electronically;
interpreting, by the processor including the user interface in response to the received indication, data associated with the electronic ballot;
generating, by the processor including the user interface, a ballot image of the interpreted electronic ballot, without accessing at least one of another device or another server to perform the interpreting or the generating;
sending, by the processor, the generated ballot image to a server containing one or more other ballot images to enable auditing of the ballot images.

2. The method of claim 1, wherein the user interface presents the electronic ballot and allows interacting with the electronic ballot including making at least one selection on the electronic ballot, wherein the user interface further includes at least one of a browser or a client application.

3. The method of claim 1, wherein the data further comprises a markup language.

4. The method of claim 1 further comprising:
encrypting, by the processor, the generated ballot image.

5. The method of claim 4, wherein the sending further comprises:
sending, by the processor, the generated ballot image after the encrypting.

6. The method of claim 1, wherein the generated ballot image is formed as a .png file.

7. The method of claim 1 further comprising:
auditing the ballot image at the server by comparing the ballot image with voting information obtained from at least three other voting channels.

8. An apparatus comprising:
a processor; and
a memory including computer program code, the memory and the computer program code configured to, with the processor, cause the apparatus to perform at least the following:
receive, at the apparatus including a user interface, an indication representative of an electronic ballot cast electronically;
interpret, by the apparatus including the user interface in response to the received indication, data associated with the electronic ballot;
generate, the apparatus including the user interface, a ballot image of the interpreted electronic ballot, without accessing at least one of another device or another server to perform the interpreting or the generating;
send, by the apparatus, the generated ballot image to a server containing one or more other ballot images to enable auditing of the ballot images.

9. The apparatus of claim 8, wherein the user interface presents the electronic ballot and allows interacting with the electronic ballot including making at least one selection on the electronic ballot, wherein the user interface further includes at least one of a browser or a client application.

10. The apparatus of claim 8, wherein the data further comprises a markup language.

11. The apparatus of claim 8, wherein the apparatus is further configured to at least encrypt the generated ballot image.

12. The apparatus of claim 11, wherein the apparatus is further configured to at least send the generated ballot image after the encrypting.

13. The apparatus of claim 8, wherein the generated ballot image is formed as a .png file.

14. The apparatus of claim 8, wherein the apparatus is further configured to at least audit the ballot image at the server by comparing the ballot image with voting information obtained from at least three other voting channels.

15. An apparatus comprising:
means for receiving, at the apparatus including a user interface, an indication representative of an electronic ballot cast electronically;
means for interpreting, by the apparatus including the user interface in response to the received indication, data associated with the electronic ballot;
means for generating, by the apparatus including the user interface, a ballot image of the interpreted electronic ballot, without accessing at least one of another device or another server to perform the interpreting or the generating;
means for sending, by the apparatus, the generated ballot image to a server containing one or more other ballot images to enable auditing of the ballot images.

16. A non-transitory computer-readable storage including computer program code which when executed by a processor causes operations comprising:
receiving, at the processor including a user interface, an indication representative of an electronic ballot cast electronically;
interpreting, by the processor including the user interface in response to the received indication, data associated with the electronic ballot;
generating, by the processor including the user interface, a ballot image of the interpreted electronic ballot, without accessing at least one of another device or another server to perform the interpreting or the generating;
sending, by the processor, the generated ballot image to a server containing one or more other ballot images to enable auditing of the ballot images.

17. The non-transitory computer-readable storage of claim 16, wherein the user interface presents the electronic ballot and allows interacting with the electronic ballot including making at least one selection on the electronic ballot, wherein the user interface further includes at least one of a browser or a client application.

18. The non-transitory computer-readable storage of claim 16, wherein the data further comprises a markup language.

19. The non-transitory computer-readable storage of claim 16 further comprising:
encrypting, by the processor, the generated ballot image.

20. The non-transitory computer-readable storage of claim 19, wherein the sending further comprises:
sending, by the processor, the generated ballot image after the encrypting.

21. The non-transitory computer-readable storage of claim 16, wherein the generated ballot image is formed as a .png file.

22. The non-transitory computer-readable storage of claim 16 further comprising:
auditing the ballot image at the server by comparing the ballot image with voting information obtained from at least three other voting channels.
